(19) United States
(12) Patent Application Publication
(10) Pub. No.: US 2020/0210545 A1
(43) Pub. Date: Jul. 2, 2020

(54) CONSTRUCTION OF STAGING TREES ON FULLY HIERARCHICAL VLSI CIRCUIT DESIGNS

(71) Applicant: International Business Machines Corporation, Armonk, NY (US)

(72) Inventors: Sven Peyer, Tuebingen (DE); Harald Folberth, Boeblingen (DE); Sven Nitzsche, Karlsruhe (DE)

(21) Appl. No.: 16/237,995

(22) Filed: Jan. 2, 2019

(51) Int. Cl. G06F 17/50

(52) U.S. Cl. CPC G06F 17/5081; G06F 2217/84; G06F 17/5072

(57) ABSTRACT

Embodiments of the invention include method, systems and computer program products for creating a circuit design using a generated tree. The computer-implemented method includes receiving, by one or more processors, a design area for a microelectronic device, wherein the design area includes a plurality of sub-units, each sub-unit from the plurality of sub-units capable of receiving a control signal. The processor determines a location of a source and one or more sinks within the design area. The processor further calculates a center of gravity (COG) based on the location of the one or more sinks. The processor connects the COG to each of the one or more sinks. The processor further connects the COG to the source.

### BACKGROUND

The present invention relates in general to electronic circuits, and more specifically, to managing and editing portions of video content.

Very large scale integrated circuit (VLSI) designs can incorporate high-speed circuits that execute functions at clock rates of several billions of cycles per second. The functions executed by these circuits are often partitioned into several stages, forming a pipeline to improve speed and overall performance. In a hierarchical VLSI design, the function partitions can be allocated to disparate hierarchical sub-units or cells to, for example, reduce design time and improve testing efficiency. To enable these disparate partitions to perform an integrated function, centrally generated control clock signals can be used to synchronize the generation of outputs from a given stage of the integrated with the consumption of inputs by another stage. Synchronization within individual partitions is also necessary. One method of addressing the synchronization problem is to distribute control clock signals across a design using a staging clock tree having multiple levels of staging latches (e.g., a staging tree). The staging latches then distribute the clock control signals to within a given sub-unit and between multiple sub-units.

### SUMMARY

Embodiments of the invention are directed to a method for creating a circuit design using a generated tree. A non-limiting example of the computer-implemented method includes receiving, by one or more processors, a design area for a microelectronic device, wherein the design area includes a plurality of sub-units, each sub-unit from the plurality of sub-units capable of receiving a control signal. The processor determines a location of a source and one or more sinks within the design area. The processor further calculates a center of gravity (COG) based on the location of the one or more sinks. The processor connects the COG to each of the one or more sinks. The processor further connects the COG to the source.

Embodiments of the invention are directed to a computer program product that can include a storage medium readable by a processing circuit that can store instructions for execution by the processing circuit for performing a method for creating a circuit design using a generated tree. The method includes receiving a design area for a microelectronic device, wherein the design area includes a plurality of sub-units, each sub-unit from the plurality of sub-units capable of receiving a control signal. The processor determines a location of a source and one or more sinks within the design area. The processor further calculates a center of gravity (COG) based on the location of the one or more sinks. The processor further connects the COG to each of the one or more sinks. The processor further connects the COG to the source.

Embodiments of the invention are directed to a system. The system can include a processor in communication with one or more types of memory. The processor can be configured to receive a design area for a microelectronic device, wherein the design area includes a plurality of sub-units, each sub-unit from the plurality of sub-units capable of receiving a control signal. The processor can be further configured to receive a design area for a microelectronic device, wherein the design area includes a plurality of sub-units, each sub-unit from the plurality of sub-units capable of receiving a control signal. The processor can be further configured to determine a location of a source and one or more sinks within the design area. The processor can be further configured to calculate a center of gravity (COG) based on the location of the one or more sinks. The processor can be further configured to connect the COG to each of the one or more sinks. The processor can be further configured to connect the COG to the source.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The subject matter that is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a diagram illustrating an exemplary operating environment according to one or more embodiments of the present invention;

FIG. 2 is a block diagram illustrating one example of a portion of the processing system one or more computing devices described in FIG. 1 for practice of the teachings herein;

FIG. 3 is a block diagram illustrating a computing system according to one or more embodiments of the present invention;

FIG. 4A illustrates an exemplary design area according to one or more embodiments of the present invention according to one or more embodiments of the present invention;

FIG. 4B illustrates an exemplary design area according to one or more embodiments of the present invention according to one or more embodiments of the present invention;

FIG. 4C illustrates an exemplary design area according to one or more embodiments of the present invention according to one or more embodiments of the present invention;

FIG. 4D illustrates an exemplary design area according to one or more embodiments of the present invention according to one or more embodiments of the present invention;

FIG. 5 is a flow diagram illustrating a method for generating a tree used to design a circuit in accordance with one or more embodiments of the present invention; and

FIG. 6 is a flow diagram illustrating a method for fabricating a circuit based on the generated tree in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. In addition, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments of the invention, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, which are related circuit design and production using electronic design automation (EDA).

Very-large-scale integration (VLSI) circuits combine thousands of transistors into a microelectronic device, where a clock distribution network (i.e., clock tree) is required to distribute clock signals from a single point to all elements requiring clock signals on the microelectronic device. As microelectronic devices and components (i.e., elements) on the microelectronic devices decrease in size, the complexity in manually creating clocking tree increases. Manually creating or using inefficient EDAs to create clock trees can lead to inefficient circuit designs, which can prove problematic when incorporated into microelectronic devices. These inefficient designs can utilize an unnecessary number of latches leading to increased power consumption and an increased space requirement needed for the layout of the circuit.

Accordingly, providing a circuit design approach that can construct clock trees while employing a reduced number of latches in comparison to current approaches is needed. The approach should also be cognizant of space, power consumption and wiring goals.

The above-described aspects of the invention address the shortcomings of the prior art by constructing a tree connecting source to sinks that can assure a similar signal/clock arrival time at all sinks within a design area (i.e., within same clock cycle). In addition, a bottom-up approach is disclosed in which a circuit design starts at sinks placed within a design area and uses a center of gravity to connect the sinks to a source in order to optimize a layout.

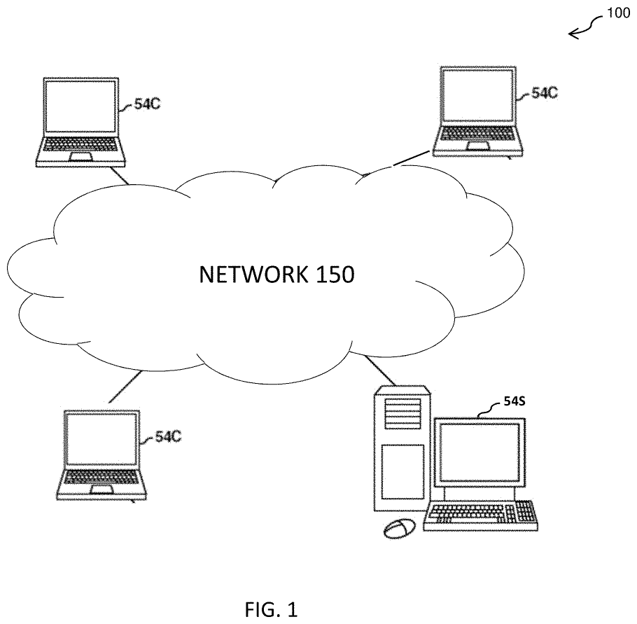

FIG. 1 is a block diagram illustrating an operating environment 100 according to one or more embodiments of the present invention. The environment 100 can include one or more computing devices, for example, server 54S and computer 54C, which are connected via network 150. The one or more computing devices may communicate with one another using network 150.

Network 150 can be, for example, a local area network (LAN), a wide area network (WAN), such as the Internet, a dedicated short-range communications network, or any combination thereof, and may include wired, wireless, fiber optic, or any other connection. Network 150 can be any combination of connections and protocols that will support communication between computer 54C, and server 54S, respectively.

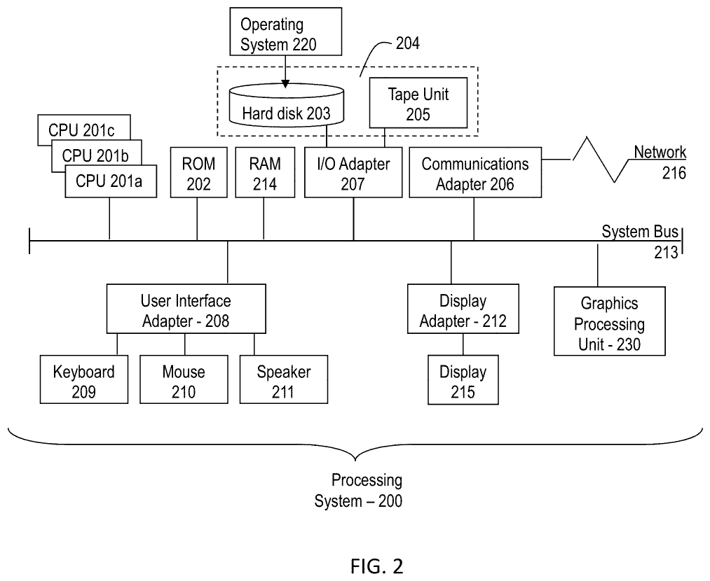

Referring to FIG. 2, there is shown an embodiment of a processing system 200 for implementing the teachings herein. The processing system 200 can form at least a portion of one or more computing devices, server 54S, and computer 54C. In this embodiment, the processing system 200 has one or more central processing units (processors) 201a, 201b, 201c, etc. (collectively or generically referred to as processor(s) 201). In one embodiment, each processor 201 may include a reduced instruction set computer (RISC) microprocessor. Processors 201 are coupled to system memory 214 and various other components via a system bus 213. Read only memory (ROM) 202 is coupled to the system bus 213 and may include a basic input/output system (BIOS), which controls certain basic functions of the processing system 200.

FIG. 2 further depicts an input/output (I/O) adapter 207 and a network adapter 206 coupled to the system bus 213. I/O adapter 207 may be a small computer system interface (SCSI) adapter that communicates with a hard disk 203 and/or tape storage drive 205 or any other similar component. I/O adapter 207, hard disk 203, and tape storage device 205 are collectively referred to herein as mass storage 204. Operating system 220 for execution on the processing system 200 may be stored in mass storage 204. A network adapter 206 interconnects bus 213 with an outside network 216 enabling data processing system 200 to communicate with other such systems. A screen (e.g., a display monitor) 215 can be connected to system bus 213 by display adaptor 212, which may include a graphics adapter to improve the performance of graphics intensive applications and a video controller. In one embodiment, adapters 207, 206, and 212 may be connected to one or more I/O busses that are connected to system bus 213 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 213 via user interface adapter 208 and display adapter 212. A keyboard 209, mouse 210, and speaker 211 can all be interconnected to bus 213 via user interface adapter 208, which may include, for example, a Super I/O chip integrating multiple device adapters into a single integrated circuit.

In exemplary embodiments, the processing system 200 includes a graphics-processing unit 230. Graphics processing unit 230 is a specialized electronic circuit designed to manipulate and alter memory to accelerate the creation of images in a frame buffer intended for output to a display. In general, graphics-processing unit 230 is very efficient at manipulating computer graphics and image processing, and has a highly parallel structure that makes it more effective than general-purpose CPUs for algorithms where processing of large blocks of data is done in parallel.

Thus, as configured in FIG. 2, the processing system 200 includes processing capability in the form of processors 201, storage capability including system memory 214 and mass storage 204, input means such as keyboard 209 and mouse 210, and output capability including speaker 211 and display 215. In one embodiment, a portion of system memory 214 and mass storage 204 collectively store an operating system to coordinate the functions of the various components shown in FIG. 2.

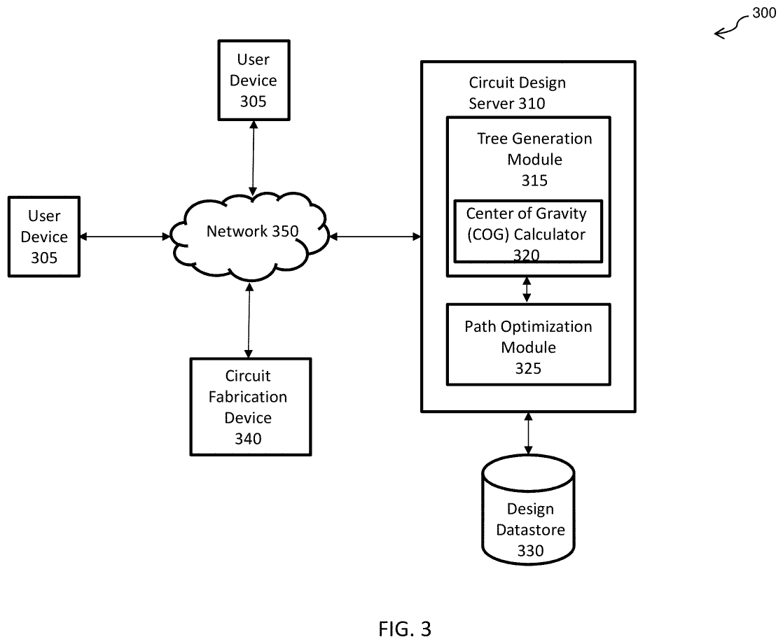

Referring now to FIG. 3, there is illustrated a computing system 300 in accordance with one or more embodiments of the invention. As illustrated, the computing system 300 can include but is not limited to, one or more user devices 305, a circuit design server 310 and a circuit fabrication system 340 connected over one or more networks, for example, network 350.

The one or more user devices 305 can be any type of computing device, such as a computer, laptop, tablet, etc. The circuit design server 310 can be any type of computing device, such as a computer, laptop, tablet, etc.

The circuit design server 310 can include a tree generation module 315 and path optimization module 325. The tree generation module 315 includes a center of gravity (COG) calculator 320. The circuit design server 310 further includes, or has access to, a circuit design datastore 330.

The circuit design server 310 can provide products related to analog circuit design, digital circuit design, integrated circuit (IC) package design, system level verification, etc., for example, via the one or more user devices 305, to a user of user device 305 for designing one or more circuits of a microelectronic device. Accordingly, during circuit design, the circuit design server 310 can receive a circuit design area or portion thereof for analysis. The design area can be a microelectronic device at a development stage.

The design area can include a plurality of shapes in which each shape can be any defined shape (e.g., quadrilateral) or any irregular shape (i.e., a shape having a combination of straight and curved edges). The COG calculator 320 can be used to calculate an iterative center location related to all sinks within the design area, which can adjust as a component (i.e., a source, sinks and latches) and wires are added, removed or moved. The COG can be used to build a tree including one or more branches (i.e., a series of validly connected latches) from an associated sink within the design area to a source.

Tree generation module 315 can calculate a location for placement of a latch within the design area, where the latch represents a base point from which tree generation module 315 can generate a clock tree for the design area and can create a connection to propagate a control signal (i.e., a clock signal). The tree generation module 315 can determine a valid placement region for placing a latch in relation to a sink on a sub-unit or another latch. The valid placement region can be an area (e.g., points or locations) on one or more sub-units of the integrated circuit where a latch can be located without, for example, violating timing requirements of the integrated circuit. A sub-unit of the design area represents a portion of the design area that includes a component that can require a connection for the propagation of a control signal (i.e., a clock signal).

Other limitations or design requirements can be used to characterize the valid placement region. The valid placement region can be determined using a maximum rectilinear distance in which the latch can be placed at a determined distance from a sink, a predecessor latch and/or each of its immediate successor latches. The valid placement region can be determined graphically by constructing (e.g., logically or graphically) a rhombus or diamond (diamond) figure around each sink, predecessor latch and each immediate successor latch. Every point within the diamond figure can be reached by the sink within, for example, one clock cycle. The vertices of the diamond around a given sink, predecessor or successor latch can be determined using a maximum distance (e.g., vertical and horizontal distance) a latch can be placed from the sink, predecessor or successor latch. The valid placement region for the latch is an area formed by the intersection of each (e.g., all) of the constructed diamonds.

Placement of a new latch can be computed based on a boundary of the diamond figure a given sink, predecessor or successor latch. The tree generation module 315 can determine a sub-unit on which to place the new latch. The selected sub-unit can be a sub-unit including at least a portion of the valid placement region and having the fewest number of sub-unit crossings (e.g., the fewest number of clock tree crossings between sub-units). This computation can also be in consideration of the COG, i.e., latch placement can occur in a direction towards the COG but within a boundary of an associated sub-unit if the diamond figure extends beyond the associated sub-unit. The computation for placement of each next new latch can cease once the placement area covers the source.

Placement optimization module 325 can minimize latches placed between a source and a sink using the COG. The placement optimization module 325 can also recalculate the COG if one or more branches within the design area reach the COG before or after other branches associated with the design area (i.e., an arrival time to the COG is different than the arrival time of other branches connected to the COG.) In addition, a new COG can be iteratively calculated based on the new latches introduced to the design area when attempting to synchronize branch arrival at the COG. Using the COG iteratively to create a circuit within the design area allows a user/designer to reduce the number of latches needed to create a clock distribution network (i.e., clock tree) which can be used to distribute clock signals from the COG to all elements requiring clock signals on a microelectronic device being designed.

Placement optimization module 325 can minimize sub-unit border crossings and rectilinear distance between every latch in the design area. Accordingly, a circuit layout can be optimized by the placement optimization module 325 using the COG to generate a layout of a clock tree by reconstructing the clock tree to reduce sub-unit crossings, trace lengths (e.g., wiring lengths), and overall power consumption. Tree generation module 315 can create and store an optimized circuit design created by the placement optimization module 325 including a tree path for the design area based on remaining latches. The optimized circuit design can be stored in the design datastore 330.

The designer can cause the optimized circuit design to be transmitted to the circuit fabrication system 340. Generally, the circuit fabrication system 340 can be used to create a wafer with multiple copies of the optimized circuit design that is fabricated and cut (i.e., diced) such that each die is one copy of an integrated circuit.

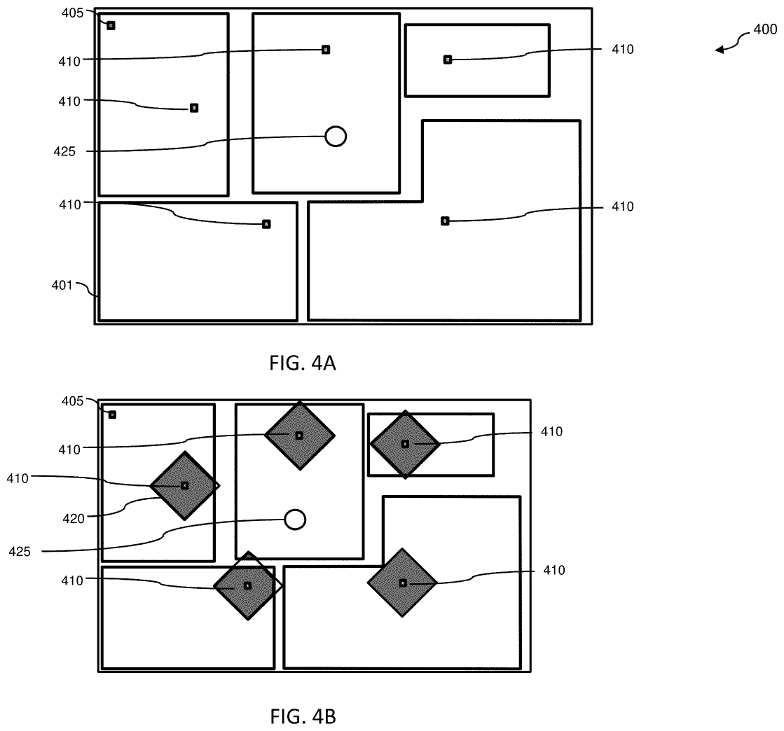

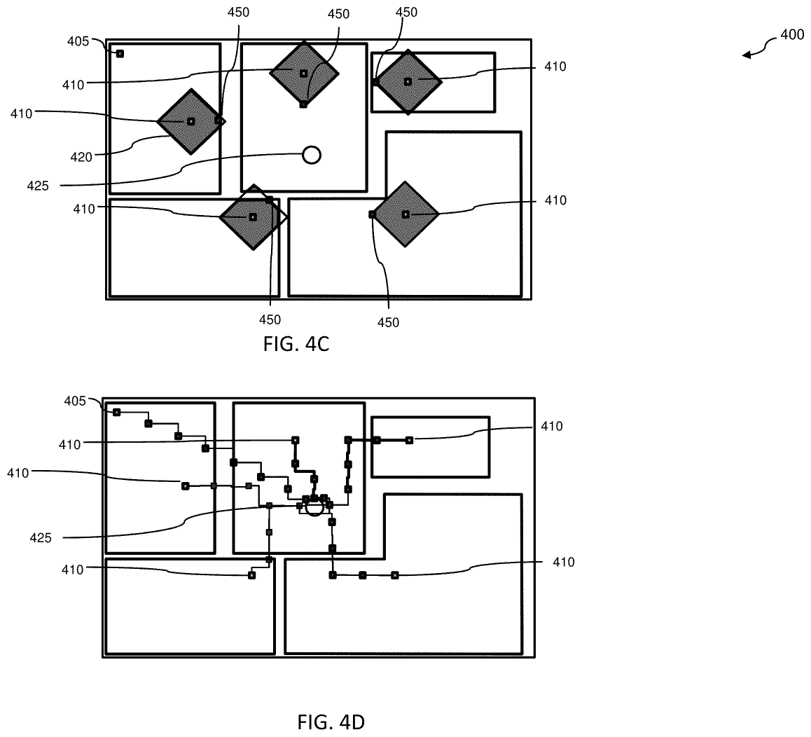

FIGS. 4A-4D are diagrams illustrating an exemplary design area 400 according to one or more embodiments of the present invention. FIG. 4A illustrates a design area 400 that includes one or more sub-units 401. A sub-unit 401 can include a source 405 and/or a sink 410. The sinks 410 on each sub-unit 401, can be used to calculate a center of gravity (COG) 425. FIG. 4B illustrates constructing (e.g., logically or graphically) a rhombus or diamond FIG. 420 around each sink 410, which can be used to determine a valid placement region for placing a new latch with a maximum rectilinear distance from an associated sink 410. FIG. 4C illustrates a placement of new latches 450 associated with a given sink 410 within or on a boundary of the rhombus or diamond FIG. 420 in a direction toward the COG 425.

FIG. 4D illustrates a plurality of branches each connecting the source 405 or an associated sink 410 to the COG 425. Each branch can be composed of one or more new latches 450, which can be placed in the design area using a rhombus or diamond FIG. 420 associated with a predecessor or successor latch. Coalescing branches around the COG 425 can reduce a number of latches needed to connect each branch to the source 405. In addition, using COG 425 can reduce the number of sub-unit crossings in an integrated circuit design, reduce clock tree wiring length, and reduce overall power consumption of the resulting microelectronic device.

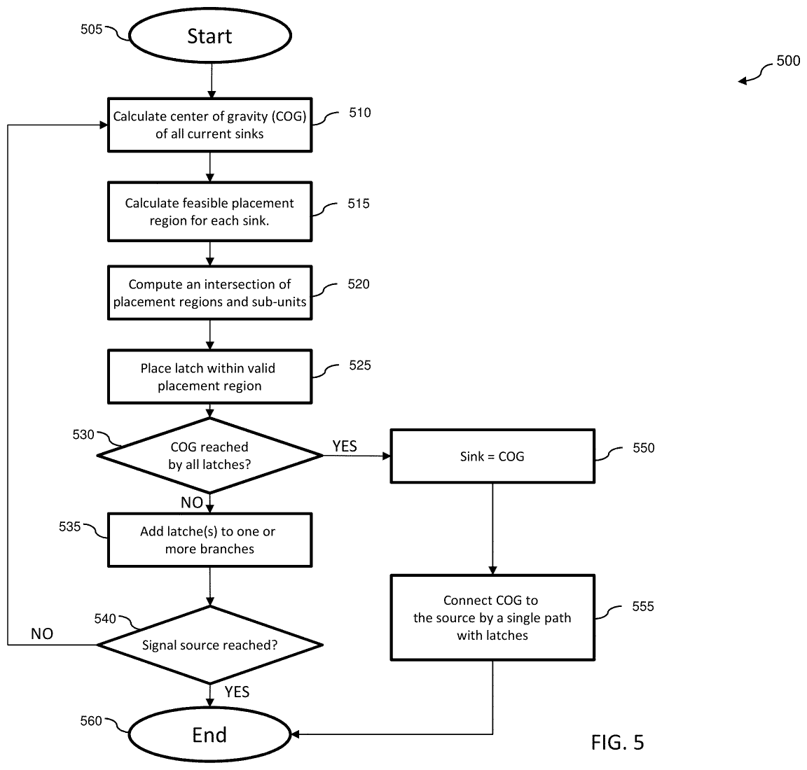

FIG. 5 is a flow diagram illustrating a computer-implemented method 500 for generating a tree used to design a circuit according to one or more embodiments of the present invention. Method 500 starts at block 505. At block 510, a server, for example, circuit design server 310, can calculate a center of gravity (COG) based on one or more sinks associated with a design area used to create a circuit. At block 515, the server can calculate a valid placement region for each sink within the design area using a rhombus or diamond (diamond) figure. At block 520, the server can compute an intersection/union of diamond figures (i.e., an overlap of two or more diamond figures) associated with placement regions and sub-units. Accordingly, by computing locations where diamond figures overlap, respective branches of the tree can be merged into a single branch. Reducing branches leads to less overhead, as well as reducing overall power consumption and/or reducing required space for the circuit.

At block 525, the server can place a latch within or on a boundary of an associated placement region. For example, one latch can be placed within an associated placement region at a shortest rectilinear distance to the sinks and the COG. At block 530, the server can determine if all latches associated with one or more branches created within the design area are connected to the COG. If the COG has not been reached by all latches with the design area, the computer-implemented method 500 proceeds to block 535, where a new latch is added to one or more of the branches using a diamond figure associated with a predecessor or successor latch. At block 540, the server can determine whether a signal source is connected to all latches and sinks within the design area. If the signal source has been reached by all latches and sinks within the design area, the computer-implemented method 500 ends at block 560. If the signal source has not been reached by all latches and sinks within the design area, the computer-implemented method 500 returns to block 510.

If the COG has been reached by all latches within the design area, the computer-implemented method 500 proceeds to block 550 where a center of gravity of all latches placed in the current iteration is determined. At block 555, the COG can be connected to the source via the latches associated with one or more branches. At block 560, method 500 ends.

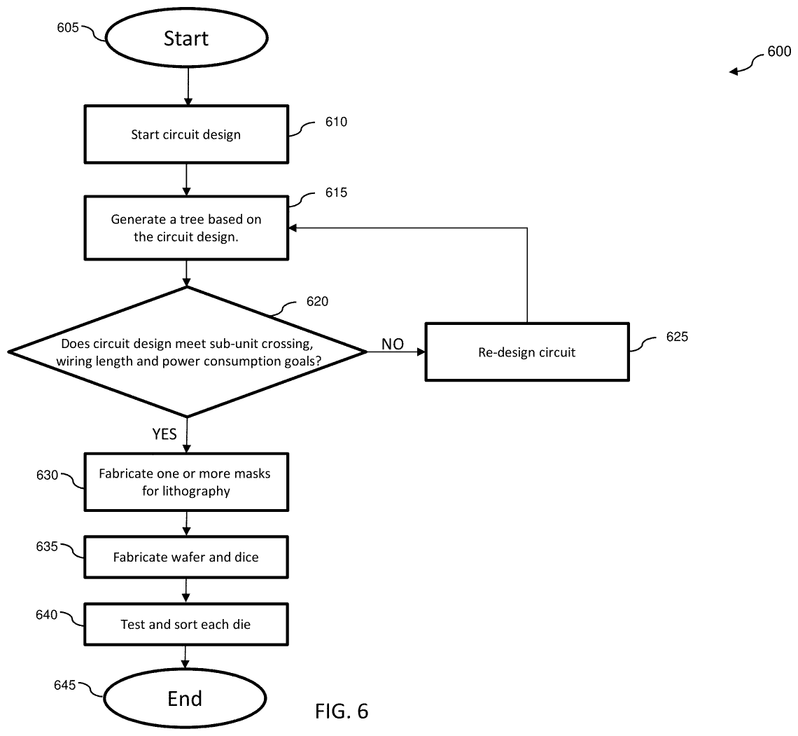

FIG. 6 is a flow diagram illustrating a computer-implemented method 600 for fabricating a circuit based on the generated tree according to one or more embodiments of the present invention. The computer-implemented method 600 starts at block 605. At block 610, a user can begin a design for a circuit using a device, for example, a user device 305, and a server, for example, circuit design server 310. At block 615, the server can generate a tree based on the user's design. At block 620, the tree generated by the server can be used to determine whether the user's circuit design meets sub-unit crossing, wiring length and power consumption goals (i.e., operational goals) allocated to the circuit. If the user's circuit design does not meet the operational goals for the circuit, the computer-implemented method 600 proceeds to block 625 where the user is instructed to re-design the circuit. The computer-implemented method then returns to block 615.

If the user's circuit design does meet the operational goals for the circuit, the computer-implemented method 600 proceeds to block 630 where the circuit design can be used to fabricate one or more integrated circuits using, for example, circuit fabrication system 340. During block 630, fabrication of masks for lithography based on an associated circuit layout can occur. At block 635, fabrication of the wafer can be performed using the fabricated masks to perform photolithography and etching. At block 640, once the fabricated wafer is diced, testing and sorting each die is performed in order to filter out any faulty die. The computer-implemented method 600 subsequently ends at block 645.

Embodiments of the present invention can construct a tree connecting the source to sinks that can assure a similar signal/clock arrival time at all sinks within a design area (i.e., within same clock cycle). Embodiments of the present invention can also reduce a number of necessary latches for a circuit design thereby reducing overall power consumption and/or reducing required space within the design area for cell placement.

Accordingly, embodiments of the present invention can employ a bottom-up approach to circuit design, which start at sinks with the design area and uses a center of gravity to connect the sinks to a source to optimize a layout. The bottom-up approach can calculate a feasible placement region for every new latch used to connect a sink to the source. When placing a new latch, the bottom-up approach minimizes a sum of rectilinear distances to all direct predecessors (latch or sink) and the center of gravity of all sinks. The bottom-up approach can also merge sub-trees whenever possible and use a single path to connect center of gravity to the source. The center of gravity is reached when it is covered by a placement area.

In addition, the center of gravity can be adaptive. Accordingly, a new center of gravity can be computed if one branch reaches original CoG earlier then other branches.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for creating a circuit design using a generated tree, the method comprising:
receiving, by one or more processors, a design area for a microelectronic device, wherein the design area includes a plurality of sub-units, each sub-unit from the plurality of sub-units capable of receiving a control signal;
determining, by the processor, a location of a source and one or more sinks within the design area;
calculating, by the processor, a center of gravity (COG) based on the location of the one or more sinks;
connecting, by the processor, the COG to each of the one or more sinks; and
connecting, by the processor, the COG to the source.

2. The computer-implemented method of claim 1, wherein connecting the COG to each of the one or more sinks comprises:
placing one or more latches between the COG and each of the one or more sinks; and
providing a wire connection from the COG to each of the one or more latches and each of the one or more sinks.

3. The computer-implemented method of claim 2, wherein the placement of each of the one or more latches is based on a valid placement region determination for each of the one or more sinks and each of the one or more latches.

4. The computer-implemented method of claim 3, wherein each of the one or more latches is placed within an associated determined placement region or on a border of the determined placement region.

5. The computer-implemented method of claim 4, wherein each of the one or more latches is placed within an associated determined placement region or on a border of the determined placement region at a location minimizing a distance between each of the one or more latches and the COG.

6. The computer-implemented method of claim 3, wherein the valid placement region determination is determined based on a maximum rectilinear distance.

7. The computer-implemented method of claim 1, further comprising:
determining an arrival time for one or more branches, each comprised of one or more latches, connecting the COG to each of the one or more sinks; and
recalculating the COG in response to one or more branches having a different arrival time in comparison to other branches of the one or more branches.

8. A computer program product for creating a circuit design using a generated tree, the computer program product comprising:
a non-transitory computer readable storage medium having stored thereon first program instructions executable by a processor to cause the processor to:
receive a design area for a microelectronic device, wherein the design area includes a plurality of sub-units, each sub-unit from the plurality of sub-units capable of receiving a control signal;
determine a location of a source and one or more sinks within the design area;
calculate a center of gravity (COG) based on the location of the one or more sinks;
connect the COG to each of the one or more sinks; and
connect the COG to the source.

9. The computer program product of claim 8, wherein the processor is further operable to:
place one or more latches between the COG and each of the one or more sinks; and
provide a wire connection from the COG to each of the one or more latches and each of the one or more sinks.

10. The computer program product of claim 9, wherein the placement of each of the one or more latches is based on a valid placement region determination for each of the one or more sinks and each of the one or more latches.

11. The computer program product of claim 10, wherein each of the one or more latches is placed within an associated determined placement region or on a border of the determined placement region.

12. The computer program product of claim 11, wherein each of the one or more latches is placed within an associated determined placement region or on a border of the determined placement region at a location minimizing a distance between each of the one or more latches and the COG.

13. The computer program product of claim 10, wherein the valid placement region determination is determined based on a maximum rectilinear distance.

14. The computer program product of claim 8, wherein the processor is further operable to:
determine an arrival time for one or more branches, each comprised of one or more latches, connecting the COG to each of the one or more sinks; and
recalculate the COG in response to one or more branches having a different arrival time in comparison to other branches of the one or more branches.

15. A system comprising:
a storage medium coupled to a processor;
the processor configured to:
receive a design area for a microelectronic device, wherein the design area includes a plurality of sub-units, each sub-unit from the plurality of sub-units capable of receiving a control signal;
determine a location of a source and one or more sinks within the design area;
calculate a center of gravity (COG) based on the location of the one or more sinks;
connect the COG to each of the one or more sinks; and
connect the COG to the source.

16. The system of claim 15, wherein the processor is further operable to:
place one or more latches between the COG and each of the one or more sinks; and
provide a wire connection from the COG to each of the one or more latches and each of the one or more sinks.

17. The system of claim 16, wherein the placement of each of the one or more latches is based on a valid placement region determination for each of the one or more sinks and each of the one or more latches.

18. The system of claim 17, wherein each of the one or more latches is placed within an associated determined placement region or on a border of the determined placement region.

19. The system of claim 18, wherein each of the one or more latches is placed within an associated determined placement region or on a border of the determined placement region at a location minimizing a distance between each of the one or more latches and the COG.

20. The system of claim 15, wherein the processor is further operable to:
determine an arrival time for one or more branches, each comprised of one or more latches, connecting the COG to each of the one or more sinks; and
recalculate the COG in response to one or more branches having a different arrival time in comparison to other branches of the one or more branches.
